(19) United States
(12) Patent Application Publication
(10) Pub. No.: US 2024/0252966 A1
(43) Pub. Date: Aug. 1, 2024

(54) FILTER DEVICE, VEHICLE, USE AND METHOD

(71) Applicant: MANN+HUMMEL GmbH, Ludwigsburg (DE)

(72) Inventors: Peter PEKNY, Neuenmarkt (DE); Junlin WU, Shanghai (CN)

(21) Appl. No.: 18/628,943

(22) Filed: Apr. 8, 2024

Related U.S. Application Data
(63) Continuation of application No. PCT/EP2022/077145, filed on Sep. 29, 2022.

(30) Foreign Application Priority Data
Oct. 7, 2021 (DE) 102021125994.0

(51) Int. Cl. B01D 46/00; B01D 46/42; B01D 46/52; B60H 3/06

(52) U.S. Cl. CPC B01D 46/0005; B01D 46/4227; B01D 46/521; B60H 3/0608; B01D 2265/024; B01D 2275/205

(57) ABSTRACT

A filter device has a filter element with filter medium body and surrounding frame with opposed lateral faces. A filter housing has opposed wall sections with two engagement counter elements for receiving with form fit an engagement element, respectively. The engagement counter elements are grooves in the wall sections with an insertion section and a blocking section connected to the insertion section and angled thereto. The insertion section permits insertion of the engagement element along a flow direction through the filter element. In the mounted state, the engagement element is arranged at one of the lateral faces of the frame, extends away from the filter medium body, and is held in the blocking section. One or several of the engagement elements are separate parts fastenable detachably to the filter element. A vehicle with such a filter device and a method for mounting the filter element with engagement elements are provided.

### CROSS-REFERENCE TO RELATED APPLICATIONS

This application is a continuation application of international application No. PCT/EP2022/077145 having an international filing date of 29 Sep. 2022 and designating the United States, the international application claiming a priority date of 7 Oct. 2021 based on prior filed German patent application No. 10 2021 125 994.0, the entire contents of the aforesaid international application and the aforesaid German patent application being incorporated herein by reference.

### BACKGROUND OF THE INVENTION

The present invention concerns a filter device, in particular interior filter device, for example, for a motor vehicle. Furthermore, the present invention concerns a vehicle with such a filter device. Still further, the present invention concerns a use of a set, comprising a filter element and a plurality of engagement elements, in the aforementioned filter device. According to yet another aspect, the present invention concerns a method for mounting a filter element in a filter housing by means of a plurality of engagement elements.

Even though applicable to arbitrary filter devices, the present invention as well as the problem underlying it will be described in the following for an interior filter of a motor vehicle.

The increasing air pollution, in particular in metropolitan cities, in combination with the use of modern air conditioning devices makes it necessary to purify, by means of suitable filters, the air which is supplied from the exterior into the interior of a motor vehicle and processed or air-conditioned. For example, particle filters, odor filters, and their combinations are conceivable for filtering out or adsorb the suspended solids, particles and odors contained in the ambient air.

For filtering air for the interior of a motor vehicle, folded or pleated filter materials, for example, filter nonwovens that form a fold pack, are frequently used. For this purpose, an initially flat filter material web is folded in a zigzag shape. The fold pack is held, for example, by lateral strips and head strips or another type of frame. Such filter elements can be fixed exchangeably in a filter housing. The thus formed filter device can be installed in an air conditioning device of a corresponding motor vehicle.

The exchange of filter elements should be performable as easily as possible. At the same time, the filter element is to be fixed safely in the corresponding filter housing. This means that the filter element is not moved out of its position in the filter housing, for example, by vibrations or pressure pulses. A further goal can reside in being able to position only those filter elements in the filter housing which are suitable for the respective application situation.

For reaching these goals, it is generally known to provide filter elements and filter housings with suitable engagement elements and engagement counter elements (respectively, receiving means). In the mounted state, these elements ensure a form fit connection securing the respective filter element in the correlated filter housing. Examples of such engagement elements and engagement counter elements can be, for example, screws with correlated threads or clips with correlated catches.

DE 10 2007 050 850 A1 describes an interior filter for a heating or air conditioning device of a motor vehicle.

### SUMMARY OF THE INVENTION

According to a first aspect, a filter device, in particular an interior filter device, for example, for a motor vehicle, is proposed. The filter device comprises a filter element with a filter medium body and a frame surrounding the filter medium body, wherein the frame comprises opposed lateral faces. Moreover, the filter device comprises a plurality of engagement elements. Furthermore, the filter device comprises a filter housing comprising, at two opposed wall sections, two engagement counter elements, respectively. One of the plurality of engagement elements can be received with form fit in the engagement counter elements, respectively. The engagement counter elements are embodied as a groove in a wall section of the filter housing, respectively. The engagement counter elements comprise: an insertion section, permitting an insertion movement of the respective engagement element substantially along the flow direction upon mounting of the filter element in the filter housing, and a blocking section connected to the insertion section and angled relative to the insertion section. Furthermore, the filter device provides that a respective engagement element in the mounted state of the filter element in the filter housing is arranged at a respective lateral face of the filter element, extends away from the filter medium body, and is held with form fit at a respective blocking section.

Advantageously, the blocking section permits a simple fastening of the filter element in the filter housing. In embodiments, one or several of the engagement elements can be moved through a respective insertion section upon mounting of the filter element in the filter housing. In other embodiments, one or several of the engagement elements can also be directly (without having to be moved beforehand through the insertion section) fastened at the blocking section with form fit. Independent therefrom, the filter housing may comprise the insertion section. In this way, various mounting possibilities are provided advantageously.

One or several of the engagement elements can be embodied, for example, as studs, projections, pins, piping etc.

The blocking section and the insertion section being connected means that they are in particular different sections of a continuous groove. An angle between the blocking section and the insertion section can amount to, for example, between 30° and 90°, preferably between 70° and 90°, further preferred 90°.

The filter housing can be configured, for example, in the form of a frame, in particular a rectangular frame. The wall sections can be partial regions of opposed sides of the frame. The filter housing can be manufactured, for example, of plastic material. In particular, the filter housing is manufactured as an injection molded plastic component. In addition or as an alternative, the filter housing can also be manufactured partially or completely of metal, in particular sheet metal.

The filter element comprises, for example, a filter medium (presently also “filter medium body”) and one or a plurality of stabilization elements, in particular lateral strips and/or head strips (also referred to as end face strips) which stabilize the filter medium at least in sections in order to maintain its shape, in particular in the filtering operation. The stabilization elements can form in particular a closed or open frame—even monolithic—which surrounds the filter medium.

The stabilization elements can be connected to the filter medium at the rim side by material fusion, in particular can be glued. For this purpose, the stabilization elements can be heated and the filter medium can be pressed into the heated material. As an alternative, the stabilization elements can be molded onto the filter medium. Furthermore, an adhesive can be used as an auxiliary material. The stabilization elements themselves can be manufactured of the same material as the filter medium. The stabilization elements can be manufactured, for example, from PET (polyethylene terephthalate), a glass fiber material, synthetic fiber material, or another plastic material or plastic material mixture or of a nonwoven. In particular, the stabilization elements can be manufactured as injection molded plastic components. The stabilization elements can be stiff or flexible (in particular also fluffy).

The lateral strips (presently also referred to as “lateral faces”) of the frame can have a grammage of, for example, 100 g/m5 to 500 g/m5, preferably 200 g/m5 to 400 g/m5. The grammage is determined according to DIN RN 29073-1 (nonwoven). The tensile strength of the lateral strips or of the lateral faces of the frame can amount to, for example, at least 100 N/50 mm, preferably at least 200 N/50 mm, even more preferred at least 500 N/50 mm in machine direction (length direction). Transverse to the machine direction, the tensile strength can amount to at least 20 N/50 mm, preferably at least 100 N/50 mm, and even more preferred at least 250 N/50 mm. The tensile strengths are determined according to DIN EN 29073-3.

Preferably, a grammage and/or a tensile strength (in machine direction and/or transverse thereto) of the lateral strips amounts to a lesser value than that of the head strips. In particular, the lateral strips are more elastic than the head strips. This means that a smaller force is required in order to bend the lateral strips by a predefined amount in comparison to the head strips.

The filter medium can be embodied folded or corrugated. As folds, for example, zigzag or W folds are known. The filter medium can be embossed and subsequently folded with formation of sharp-edged fold edges along embossment edges. A flat material filter web which is then correspondingly shaped can serve as a starting material. The filter medium is, for example, a filter fabric, a laid filter material or a filter nonwoven. In particular, the filter medium can be produced by a spun-bonding or melt blowing method. Furthermore, the filter medium can be felted or needled. The filter medium can comprise natural fibers, such as cotton, or plastic fibers, for example, of polyester, polyphenyl sulfide or polytetrafluoroethylene. During processing, the fibers can be oriented in, at a slant to, and/or transverse to the machine direction.

The filter medium can be a single layer or comprise multiple layers. It can comprise furthermore an adsorption agent such as active carbon. Furthermore, the filter medium can comprise an antimicrobial and/or anti-allergic action. As antimicrobial substance, for example, zinc pyrithione or nanosilver, as anti-allergic substance, for example, polyphenol, is conceivable.

A corresponding filter element serves for filtering fluids, i.e., gaseous and/or liquid media, for example, air. A gaseous medium or air comprises here also gas or air/solid mixtures and/or gas or air/liquid mixtures. For example, an air conditioning device can comprise the filter element.

An in particular open filter medium can be designed to remove particles of the test dust A4 according to ISO 12103-1 from an air flow with a filtration speed of 0.10 m/s to 0.30 m/s, in relation to the filter medium surface, for an air permeability of larger than 3,000 l/m2s (determined according to ISO 9237 at 200 Pa). Determining the filtration characteristic values can be realized, for example, according to DIN 71460-1.

An in particular high-separation filter medium can be designed to remove particles of the test dust A2 according to ISO 12103-1 as well as NaCl aerosol particles according to DIN 71460-1 from an air flow with a filtration speed of 0.10 m/s to 0.30 m/s, in relation to the filter medium surface, for an air permeability of larger than 600 l/m2s (determined according to ISO 9237 at 200 Pa). Determining the filtration characteristic values can be realized, for example, according to DIN 71460-1.

The filter element can comprise a seal which seals a raw side correlated with the filter element in relation to a clean side thereof. The seal can be designed to be the one and the same component with one or several stabilization elements of the filter element. Alternatively, the seal can be designed as an additional component. For example, the seal can be attached to the filter medium, one or several of the stabilization elements, the filter element, or the filter housing.

The filter element can be fixed exchangeably in the filter housing.

The filter device can be used in passenger cars, trucks, construction machines, watercraft, rail vehicles, aircraft as well as generally in air conditioning technology, in particular in heating and air conditioning devices, in household appliances, in fuel cells, or in building technology. These motor vehicles or vehicles can be operated electrically and/or by means of fuel (in particular gasoline or diesel). In regard to building technology, in particular stationary devices for the treatment of air are conceivable.

According to an embodiment, the two engagement counter elements are embodied so as to extend oppositely.

This means that, for example, the two engagement counter elements have corresponding elements which either extend quasi toward each other or quasi away from each other. For example, the blocking sections of the two engagement counter elements can extend toward each other or away from each other.

According to a further embodiment, the two engagement counter elements each have an L-shaped geometry. Preferably, the L-shaped geometries are arranged mirror-symmetrically to each other.

A corresponding symmetry axis can extend, for example, in direction of the flow direction and divide a correlated lateral face into two identical surfaces.

According to a further embodiment, one leg of the L shape corresponds to the insertion section and the other leg of the L shape to the blocking section.

That one leg can end at a rim of the corresponding lateral face which, for example, corresponds to the raw side or clean side of the filter element. The other leg can extend parallel to the rim of the lateral face, for example. The legs of the L shape can be of same length or of different lengths. Instead of the L shape, also any other angled geometry can be provided.

According to a further embodiment, the two blocking sections of the two engagement counter elements face away from each other. Preferably, the two insertion sections are arranged parallel to each other.

According to a further embodiment, a distance between the engagement elements in an undeformed state of the filter element is larger than a distance between the two insertion sections of a wall section of the filter housing so that the engagement elements may snap into the blocking sections at the end of the insertion movement.

According to this embodiment, the engagement elements are first moved closer to each other (by deformation of the filter element) in order to be insertable into the respective insertion section. For example, a filter element comprising two engagement elements at its lateral faces can be fastened easily in the two engagement counter elements with form fit. This is so because the filter element is bent about an axis perpendicular to the aforementioned lateral faces. In this way, the distance between the engagement elements is reduced. They can therefore be easily inserted into the respective insertion section. As soon as the engagement elements have reached the respective blocking section, the filter element is released again so that the latter assumes its undeformed initial position. In doing so, the engagement elements move along their respective blocking section. The engagement elements then are positioned at the end of a respective blocking section (end of the other leg). In this way, a form fit connection exists between the filter element and the filter housing via the engagement elements. This form fit connection can be released in that the filter element is again deformed. This deformation is counteracted by the stiffness of the frame (in particular the stiffness of its lateral faces). In general, one can speak of the filter element being locked with the filter housing by means of the plurality of engagement elements, wherein the locked connection is secured by the stiffness of the frame or of the lateral faces.

One or several of the engagement elements are formed as separate parts.

This means that one or several of the engagement elements in the unmounted state of the filter device are neither connected to the filter element nor to the filter housing. In particular, one or several of the engagement elements are not formed as one piece or one part together with the filter element or the filter housing. Therefore, they can be manufactured more easily.

One or several of the engagement elements are detachably fastenable to the filter element.

The detachable attachment is realized for mounting the filter element in the filter housing. In particular, one or several of the engagement elements connect the filter element and the filter housing to each other by means of a form fit connection.

According to a further embodiment, the respective blocking section comprises a pocket or through opening in the wall section. Preferably, the respective engagement element in the mounted state engages with form fit the pocket or the through opening and in particular is snapped into it.

In this way, the engagement element can be connected easily to the correlated blocking section.

According to a further embodiment, the lateral faces of the frame of the filter element each have two through openings. The through openings may be positioned opposite a respective blocking section in the mounted state of the filter element in the filter housing. In the mounted state, a respective engagement element passes through one of the two through openings and, further preferred, engages the respective blocking section with form fit.

In this case, an engagement element in the form of a stud or pin is particularly advantageous. The engagement element couples in this context in a simple manner the frame of the filter element to the filter housing.

According to a further embodiment, the filter device comprises hold sections which are connected to a respective engagement element and, in the mounted state, are arranged in a recessed region of the filter medium body. Preferably, the recessed region of the filter medium body is accessible from the side from which mounting of the filter element in the filter housing is realized.

For example, the recessed region in the filter medium body is provided in that the latter is designed as a pleated fold bellows. The recessed region in this context can be a region between two folds. Preferably, the recessed region is formed by a fold spacing which is enlarged in sections. This means that the distance between two neighboring folds or fold edges is larger than between two or more other folds or fold edges of the filter medium body. In this way, the respective engagement element can be accommodated in a space-saving manner. The hold section can comprise a grip section for the manual mounting of the engagement element at the filter element and/or in the filter housing. In this way, the engagement elements can be handled more easily.

According to a further embodiment, the filter device comprises hold sections which are connected to a respective engagement element and, in the mounted state, at least partially engage around or from behind the filter element. In particular, the hold sections engage around or from behind the filter element at its inflow side and/or outflow side and/or at an inflow side rim and/or outflow side rim of the frame of the filter element.

In this way, the engagement elements can hold the filter element in a simple manner.

According to a further embodiment, the respective hold sections have a cross shape. The respective engagement element may be arranged at the bottom end of the cross shape. The cross shape may engage from behind laterally the filter element, in particular at the inflow side rim and/or outflow side rim of the frame of the filter element, and/or the wall of the filter housing. A top end of the cross shape may comprise a grip section for manual mounting of the engagement element at the filter element and/or filter housing.

The cross shape may be combined of four stays which are arranged at a right angle relative to each other. The stays are connected to each other at the same fastening location, wherein the fastening location is provided at a respective end of the four stays. The stays can have the same length or can be of different lengths. In particular, a bottom section can be longer than a top section. The two lateral sections can be shorter than the long bottom section. The top section may correspond to the grip section. Instead of the cross shape, the hold sections can also comprise a T shape. The respective engagement element can be arranged at the bottom end of the vertical stay of the T shape. The horizontal stay of the T shape can engage from behind the filter element, in particular at the inflow side rim and/or outflow side rim of the frame of the filter element, and/or the wall of the filter housing. Stated differently, the grip section is missing in this embodiment, for example.

According to a further embodiment, two of the plurality of engagement elements or two of the hold sections are connected by means of a connection piece, respectively.

In this way, the engagement elements can secure themselves mutually in their mounted position. Furthermore, the engagement elements can be handled more easily in this way.

According to a further embodiment, the connection piece extends parallel or perpendicularly to the lateral faces of the frame in the mounted state.

In this way, either engagement elements arranged at the same side of the filter element can be connected to each other (connection piece extends parallel) or engagement elements arranged at opposed sides of the filter element can be connected to each other (connection piece extends perpendicularly).

According to a further embodiment, two of the plurality of engagement elements, which are arranged at opposed lateral faces of the frame or at the same lateral face of the frame, are connected to each other by means of the connection piece, respectively.

According to a further embodiment, the connection piece is elastically deformable for insertion of the engagement elements into the respective blocking section.

In this way, the connection piece (due to its elasticity or stiffness) can secure in particular the position of the engagement elements in their respective blocking section so that they do not accidentally disengage therefrom.

According to a further embodiment, the connection piece extends across fold tips of the filter medium body and/or in a recessed region through the filter medium body.

In this way, the connection piece can be accommodated in a beneficial manner.

According to a second aspect, a vehicle with the aforementioned filter device is provided.

According to a third aspect, the use of a set, comprising a filter element and a plurality of engagement elements, in a filter device, as described above, is proposed. The filter element comprises a filter medium body and a frame surrounding the filter medium body. The frame comprises opposed lateral faces. A respective engagement element is configured to be arranged, in a mounted state of the filter element in the filter housing, at a respective lateral face of the filter element, to extend away from the filter medium body, and to be held in a respective blocking section of the filter housing with form fit.

Such a set is beneficial, for example, for the exchange of a spent filter element in the filter device. Alternatively, such a set can also be used in the context of initially equipping a filter device, as described above, with a corresponding filter element. By means of the engagement elements, the filter element can be connected with form fit in a simple manner to the filter housing by using the blocking section.

According to an embodiment, the respective engagement element is configured to be inserted along a respective insertion section of the filter housing substantially along the flow direction upon mounting of the filter element in the filter housing.

Correspondingly, the insertion section which is present, as needed, in the filter housing can be, but must not be, used in the context of exchanging the, for example, spent filter element or for newly equipping the filter device with a filter element. For example, the engagement elements in embodiments can also be fastened immediately at the blocking section, as already explained above.

According to a fourth aspect, a method for mounting a filter element in a filter housing by means of a plurality of engagement elements is proposed. The filter element comprises a filter medium body and a frame surrounding the filter medium body. The frame comprises opposed lateral faces. The filter housing comprises at two opposed wall sections two engagement counter elements, respectively. In the engagement counter elements, one of the plurality of engagement elements is receivable with form fit, respectively. The engagement counter elements each are formed as a groove in a wall section of the filter housing and comprise: an insertion section, permitting an insertion movement of the respective engagement element substantially along the flow direction upon mounting of the filter element in the filter housing, and a blocking section which is connected to the insertion section and angled relative to the insertion section, wherein the method comprises:
a) inserting the filter element into the filter housing, and
b) arranging a respective engagement element at a respective lateral face of the filter element in such a way that it extends away from the filter medium body and is held with form fit in a respective blocking section.

According to an embodiment, the respective engagement element is inserted along a respective insertion section of the filter housing substantially along the flow direction prior to step b).

This means, even though the filter element comprises the insertion section, the latter must not be utilized in the context of the mounting method for attachment of the engagement element in its blocking section.

The features and advantages described in connection with the first aspect apply correspondingly to the further afore described aspects, and vice versa.

Further possible implementations of the invention comprise also combinations, not explicitly mentioned, of features or method steps described above or in the following in relation to the embodiments. In this context, a person of skill in the art will also add individual aspects as improvements or supplements to the respective basic form of the invention.

Further embodiments of the invention are subject matter of the dependent claims as well as of the embodiments of the invention described in the following. In the following, the invention will be explained in more detail with the aid of embodiments with reference to the attached Figures.

### BRIEF DESCRIPTION OF THE DRAWINGS

FIG. 1 shows a schematic illustration of a motor vehicle with a filter device.

FIG. 2 shows a perspective illustration of the filter device of FIG. 1 comprising a filter housing with an interior filter arranged therein.

FIG. 3 shows a perspective illustration of the interior filter of FIG. 2 comprising a frame and a filter medium.

FIG. 4 shows in a perspective illustration the filter medium of FIG. 3.

FIG. 5A shows in a perspective view a filter device according to a first embodiment.

FIG. 5B shows a section I-I of FIG. 5A.

FIG. 5C shows a section II-II of FIG. 5A.

FIG. 6 shows an exploded view of the filter device according to FIGS. 5A to 5C.

FIG. 7A shows in a perspective view a filter device according to a second embodiment.

FIG. 7B shows a section I-I of FIG. 7A.

FIG. 7C shows a section II-II of FIG. 7A.

FIG. 8 shows an exploded view of the filter device according to FIG. 7A to 7C.

FIG. 9A shows in a perspective view a filter device according to a third embodiment.

FIG. 9B shows a section I-I of FIG. 9A.

FIG. 9C shows a section II-II of FIG. 9A.

FIG. 10 shows in an exploded view the filter device according to FIGS. 9A to 9C.

FIG. 11, FIG. 12, FIG. 13, FIG. 14, and FIG. 15 show various embodiments of filter elements together with the correlated engagement elements.

FIG. 16 shows a method according to an embodiment.

In the Figures, same or functionally the same elements, if nothing to the contrary is mentioned, are provided with the same reference characters.

### DETAILED DESCRIPTION

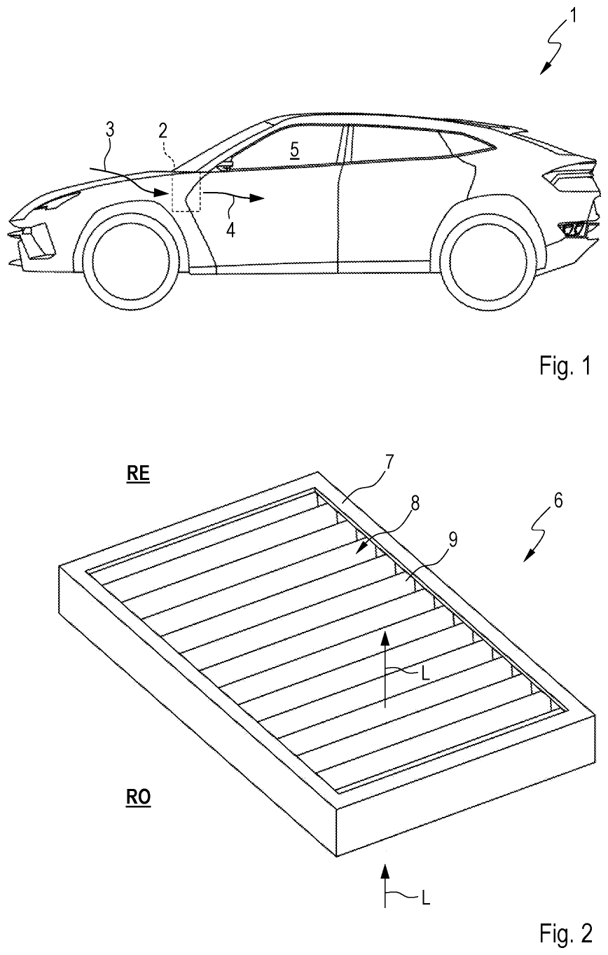

FIG. 1 shows a motor vehicle 1 with an air conditioning device 2 which is designed as a heating and air conditioning device. The air conditioning device 2 takes in ambient air 3 and supplies filtered air 4 to a cabin 5 of the motor vehicle 1. For this purpose, the air conditioning device 2 comprises a filter device 6 illustrated in FIG. 2.

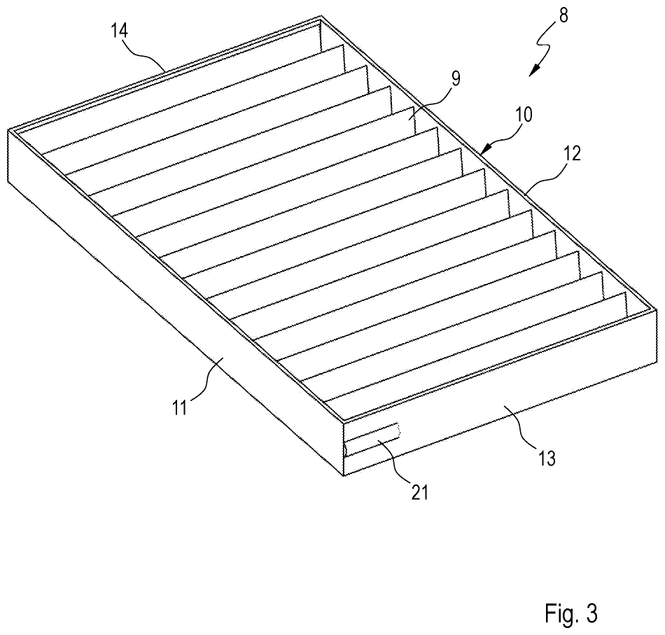

The filter device 6 comprises a filter housing 7 with an interior filter 8 (presently also “filter element”) exchangeably arranged therein. The interior filter 8 is illustrated in more detail in FIG. 3. The interior filter 8 comprises a filter medium 9 (presently also “filter medium body”) which is connected in particular all around to a frame 10 (FIG. 3). The frame 10 can comprise, for example, lateral strips 11, 12 and head strips 13, 14.

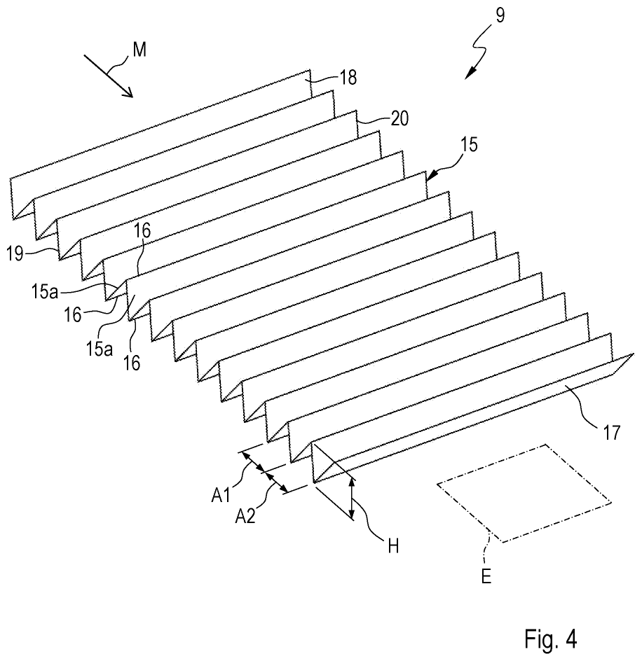

The filter medium 9 is illustrated in FIG. 4 in isolation. For example, the filter medium 9 is a filter nonwoven, filter fabric, laid filter material or filter felt, in particular a needled felt. In particular, the filter medium 9 can be produced in a melt blowing method. The filter medium 9 can comprise natural fibers, such as cotton, or plastic fibers, for example, of polyester, polyphenyl sulfide or polytetrafluoroethylene. During processing, the fibers can be oriented in, at a slant to, and/or transverse to the machine direction M. Also, the fibers can be stretched in a spatial direction. The filter medium 9 can be a single layer or comprise multiple layers.

The filter medium 9 can have folds 15 which extend typically transversely to the machine direction M. The folded filter medium 9 is also referred to as pleating. The folds 15 can be produced by means of folding along sharp fold edges 16 (also referred to as “fold tips”) or as a corrugated embodiment of the filter medium 9. A respective fold 15 can be defined by two fold sections 15a which are connected to each other by a corresponding fold edge 16. According to the embodiment, the fold edges 16 face in or opposite to the inflow direction or flow direction, which is indicated in FIG. 2 by the arrow L. Folding can be embodied in particular as a zigzag folding.

Folding in which the folds 15 have a variable height H is possible also. Furthermore, the fold distance between the folds 15 can vary so that the distance A1 is different from the distance A2. The filter medium 9 can be designed to be self-supporting, i.e., the folds are shape-stable for an intended flow therethrough in the filtering operation.

The filter medium 9 is limited in machine direction M by end folds 17, 18. Transverse thereto, the filter medium 9 is delimited by fold end face edges 19, 20 (also referred to as fold profiles). “Fold end face edge” means the end face fold surface which extends between neighboring fold edges 16 of a respective fold 15.

The filter medium 9 can have a rectangular shape in the plan view, i.e., in the plane E of its areal extension. However, also a triangular, pentagonal or polygonal, round or oval shape are conceivable.

The lateral strips 11, 12 illustrated in FIG. 3 are connected to the fold end face edges 19, 20, the head strips 13, 14 to the end folds 17, 18, in particular by melting, welding or gluing. The lateral strips 11, 12 as well as the head strips 13, 14 can form the frame 10 as one piece or as multiple pieces. The lateral strips 11, 12 as well as the head strips 13, 14 can be manufactured, for example, of an in particular flexible fiber material or as, in particular stiff, injection molded plastic parts. In particular, the frame 10 can be produced by molding onto the filter medium 9.

The filter medium 9 can function as particle filter and filter out particles, in particular dust, suspended solids, or liquid droplets from the intake air 3. In addition, the filter medium 9 can function as an odor filter. For this purpose, it can comprise, for example, a layer of active carbon. The filter medium 9 in general can be designed to absorb or adsorb certain solid, liquid and/or gaseous substances.

In filtering operation, the filter medium 9, as illustrated in FIG. 2, is flowed through perpendicularly to its areal extension by air (flow direction L). The air (flow direction L) flows in this context from a raw side RO of the interior filter 8 to a clean side RE thereof.

In order to ensure a satisfactory sealing action between the raw and clean side RO, RE, a seal can be provided between the interior filter 8 and the filter housing 7. The seal can be integrated into the frame 10, for example. In this case, the frame 10 is formed at least partially of a sealing material. Alternatively, the seal can be provided as an additional part, for example, attached to the frame 10, in particular molded thereto. Such a seal 21 is illustrated in an exemplary fashion and partially in FIG. 3.

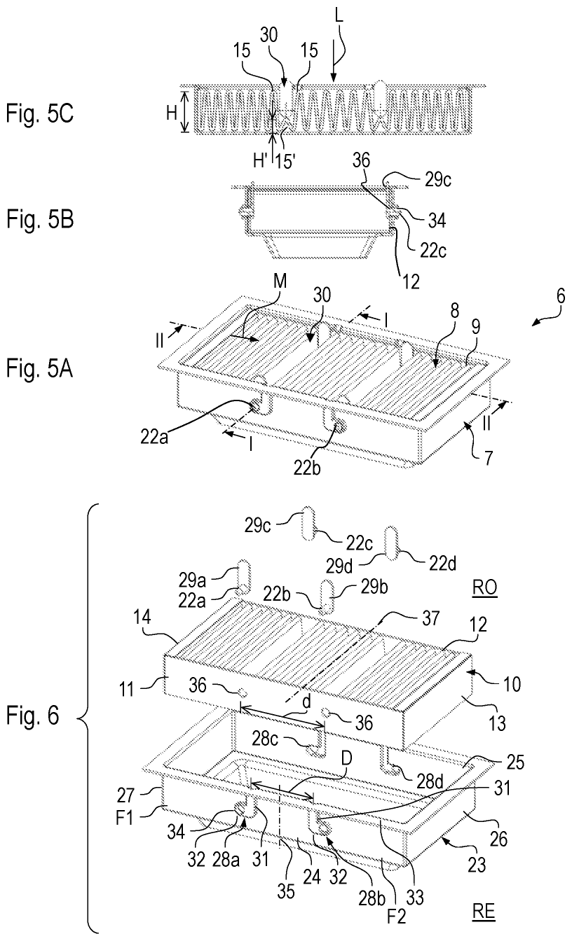

FIG. 5A shows in a perspective view a filter device 6 according to a first embodiment. FIG. 5B shows a section I-I, FIG. 5C a section II-II of FIG. 5A. FIG. 6 shows an exploded view of the first embodiment. In the following, reference is being had jointly to FIGS. 5A to 6.

The filter device 6 comprises a filter housing 7 (FIG. 5A) with filter element 8 received therein. The filter element 8 is held in the illustrated mounted position by means of a plurality of engagement elements 22a to 22d (FIG. 6).

A filter medium or filter medium body is identified in the Figures by 9. It is surrounded by a surrounding frame 10. The latter is comprised of lateral strips 11, 12 (presently also “lateral faces”) and head strips 13, 14.

The filter housing 7 comprises, for example, also a frame 23 which is comprised, for example, of opposed wall sections 24, 25 (FIG. 6) as well as 26, 27, respectively. In this context, the wall sections 24, 25 are positioned opposite the lateral strips 11, 12, the wall sections 26, 27 opposite the head strips 13, 14. The filter housing 7 could also have a different shape.

According to the embodiment, the wall sections 24, 25 are embodied each with two engagement counter elements 28a to 28d (FIG. 6). In them, one of the engagement elements 22a to 22d can be received with form fit, respectively. The engagement counter elements 28a to 28d each are embodied as a groove, for example. The engagement counter elements 28a, 28b are formed in this context in the wall section 24, the engagement counter elements 28c, 28d in the wall section 25. The filter housing 7 together with the engagement counter elements 28a to 28d can be manufactured, for example, of plastic material, in particular in an injection molding process.

The engagement elements 22a to 22d are embodied as studs, for example. In particular, they can be provided, as illustrated in FIGS. 5A to 6, at an end of a hold section 29a to 29d or can be formed as one piece therewith. The hold sections 29a to 29d can be manufactured in the form of tabs. These tabs can provide a grip section for gripping the engagement elements 22a to 22d during assembly of the filter device 6 and can be easily gripped by hand. In the mounted state, the hold sections 29a to 29d can be arranged, for example, at least partially (or completely) in recessed regions 30. As can be seen in FIG. 5C, such recessed regions 30 can be formed in that a fold 15′ of the filter medium body 9 is configured with a reduced height H= compared to the folds 15 adjoining the fold 15′ at both sides and each provided with a height H.

The counter engagement elements 28a to 28d can be designed in detail as follows. As explained in the following in an exemplary fashion for the engagement counter element 28a (FIG. 6), each of the engagement counter elements 28a to 28d comprises an insertion section 31 and a blocking section 32. The sections 31, 32 are preferably part of the same continuous groove. The insertion section 31 extends preferably in the flow direction L (see FIG. 5C). It extends from an inflow-side rim 33 of the wall section 24, for example, toward a center thereof. Here, the insertion section 31 adjoins the blocking section 32 at an angle of, for example, 90°. In this way, an L shape results. At the end of the blocking section 32, a through hole 34 can be provided. The latter penetrates the material of the wall section 24 completely. Instead, only a pocket can be provided also which is configured so as to be inwardly open (accessible). The inflow side corresponds to the raw side RO of FIG. 2.

As can be seen in FIG. 6, the engagement counter elements 28a, 28b are designed to extend oppositely. For example, the blocking sections 32 extend in opposite directions. In contrast thereto, the insertion sections 31 are arranged parallel to each other. In particular, the engagement counter elements 28a, 28b can be configured to be mirror-symmetrical in relation to a symmetry axis 35. The symmetry axis 35 is oriented in the flow direction L and divides the wall section 24 into surfaces F1, F2 of approximately same size.

The engagement elements 22a to 22d, together with their hold sections 29a to 29d, are presently designed as separate parts, i.e., in the unmounted state (FIG. 6) they are neither connected to the filter housing 7 nor to the filter element 8. Instead, they are connectable detachably to the filter element 8 and the filter housing 7 in order to secure in this way the filter element 8 in its mounted position in the filter housing 7, to be explained in more detail in the following.

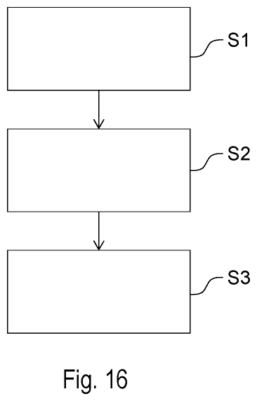

For example, two through holes 36 are formed in the lateral strips 11, 12, respectively. After insertion of the filter element 8 into the filter housing 7, the through holes 36 are positioned opposite the through holes 34 in the engagement counter elements 28a, 28b (step S1 of the method illustrated in FIG. 16).

In a further step, the engagement elements 22a to 22d are moved into the recessed regions 30 and from there, from the interior, pushed through the through holes 36 into the through holes 34. Correspondingly, a respective engagement element 22a to 22d is arranged at a respective lateral face 11, 12 and extends away from the filter medium body 9. Since the engagement elements 22a to 22d pass through the through hole 36 as well as the through hole 34, respectively, a form fit connection results between them and the filter housing 7 and the filter element 8 (method step S2 in FIG. 16).

Alternatively, the engagement elements 22a to 22d can be already positioned in the respective through holes 36 prior to the insertion of the filter element 8 into the filter housing 7. Then, the filter element 8, for example, by hand, is bent about an axis 37. The axis 37 extends, for example, perpendicularly to the lateral faces 11, 12. Due to this deformation (not illustrated), the through holes 36, which, in the undeformed state, have a larger distance d relative to each other than the insertion sections 31, move closer together (not illustrated). The distance between them is identified by D in FIG. 6. Correspondingly, due to the deformation, the engagement elements 22a to 22d can then be inserted into the insertion sections 31 opening up into the rim 33. Then, the engagement elements 22a to 22d are pushed along the respective insertion section 31 in the flow direction L, in FIG. 6 downwardly, until they reach the respective blocking section 32 connected to the insertion sections 31. This corresponds to method step S3 of FIG. 16.

Then, the filter element 8 is released so that it can return into its initial state. In doing so, the engagement elements 22a to 22d each move outwardly along the blocking sections 32 and engage finally with form fit the through holes 34, for which purpose pressure is applied onto the engagement elements 22a to 22d from the interior, for example, by hand.

Advantageously, the hold sections 29a to 29d are accessible from the mounting side, from which the filter element 8 is inserted into the filter housing 7 and which presently corresponds to the raw side RO, and can be moved for demounting the filter element 8 simply by hand inwardly so that the engagement elements 22a to 22d become disengaged from the through holes 34, 36.

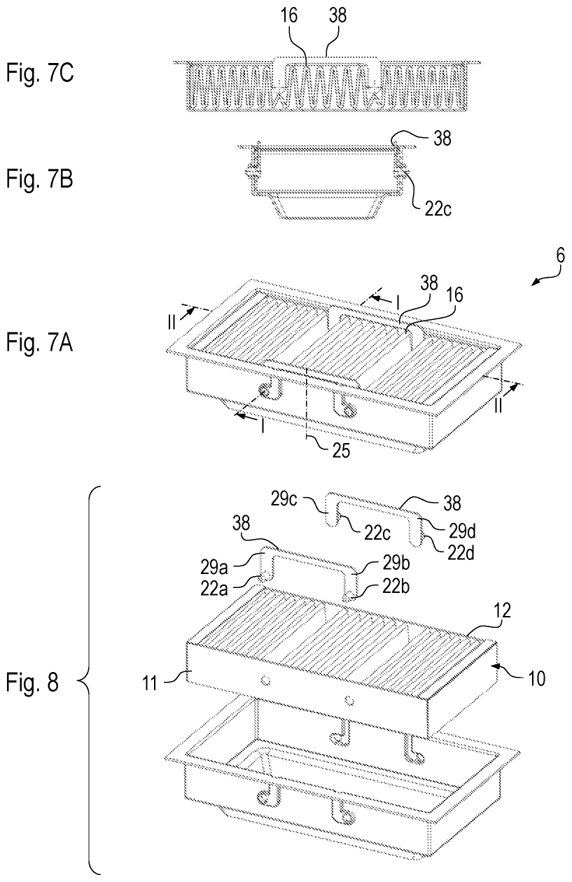

FIG. 7A shows a filter device 6 according to a second embodiment in perspective view. FIG. 7B shows a section I-I, FIG. 7C a section II-II of FIG. 7A. FIG. 8 shows an exploded view of the second embodiment. The following explanations relate to FIGS. 7A to 8 together, wherein primarily differences in regard to the first embodiment according to FIGS. 5A to 6 will be explained.

In the second embodiment, in contrast to the first embodiment, the hold sections 29a, 29b or 29c, 29d of respective two engagement elements 22a, 22b or 22c, 22d arranged at the same lateral face 11 or 12 are connected by a respective connection piece 38. The connection piece 38 in the mounted state, as shown in FIG. 7A, is arranged parallel to the lateral face 11. In addition, it extends above fold tips or fold edges 16.

The connection piece 38 can be designed to be elastic. This applies primarily to the mounting variant in which the engagement elements 22a, 22b or 22c, 22d are guided along the insertion sections 31 of the engagement counter elements 28a to 28d because the distance between the neighboring engagement elements 22a, 22b or 22c, 22d is reduced in this case (compare the above explanations in regard to the distances d and D in connection with FIG. 6). As soon as the engagement elements 22a to 22d reach their respective blocking section 32 at the end of the respective insertion section 31, they snap elastically outwardly into the end of a respective blocking section 32. The thus provided form fit connection is secured by the respective connection piece 38 due to its elasticity or stiffness.

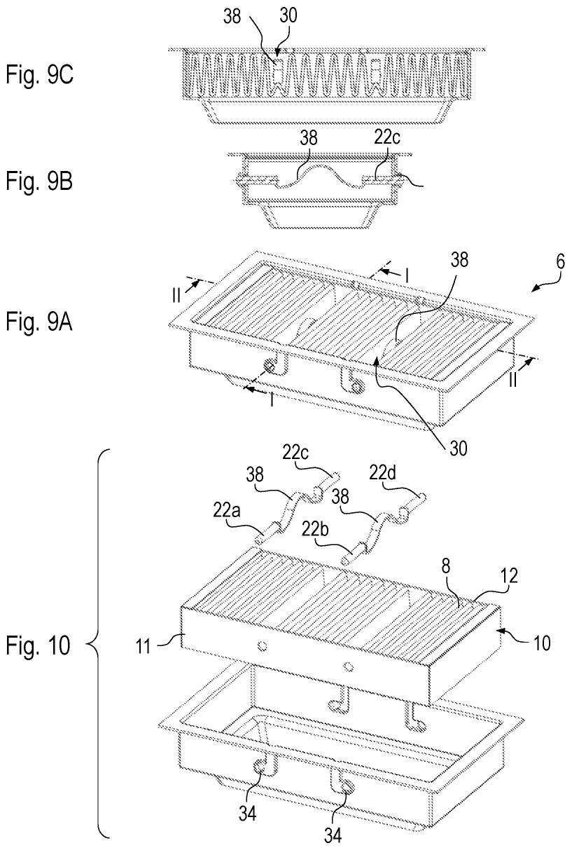

FIG. 9A shows in a perspective view a third embodiment of a filter device 6. FIG. 9B shows a section I-I, FIG. 9C a section II-II of FIG. 9A. FIG. 10 illustrates an exploded view of the third embodiment. In the following, reference is being had to FIGS. 9A to 10 together, wherein primarily the differences in relation to the afore described embodiments will be explained.

In contrast to the second embodiment according to FIGS. 7A to 8, in the third embodiment according to FIGS. 9A to 10, the engagement elements 22a, 22c or 22b, 22d, which are arranged at different lateral faces 11, 12 of the frame 10, are connected by a respective connection piece 38. The connection piece 38 is advantageously elastic and, as needed, additionally curved so that it secures the engagement elements 22a to 22d in their respective engagement position with the through holes 34. For this purpose, the connection piece 38 pretensions the engagement elements 22a, 22c or 22b, 22d provided at its ends in outward direction, i.e., in a direction away from the filter element 8, in the mounted state. The connection pieces 38 in this case are arranged in a direction perpendicularly to the lateral faces 11, 12. In addition, the connection pieces 38 can extend partially or completely in the recessed regions 30 (see FIG. 9C).

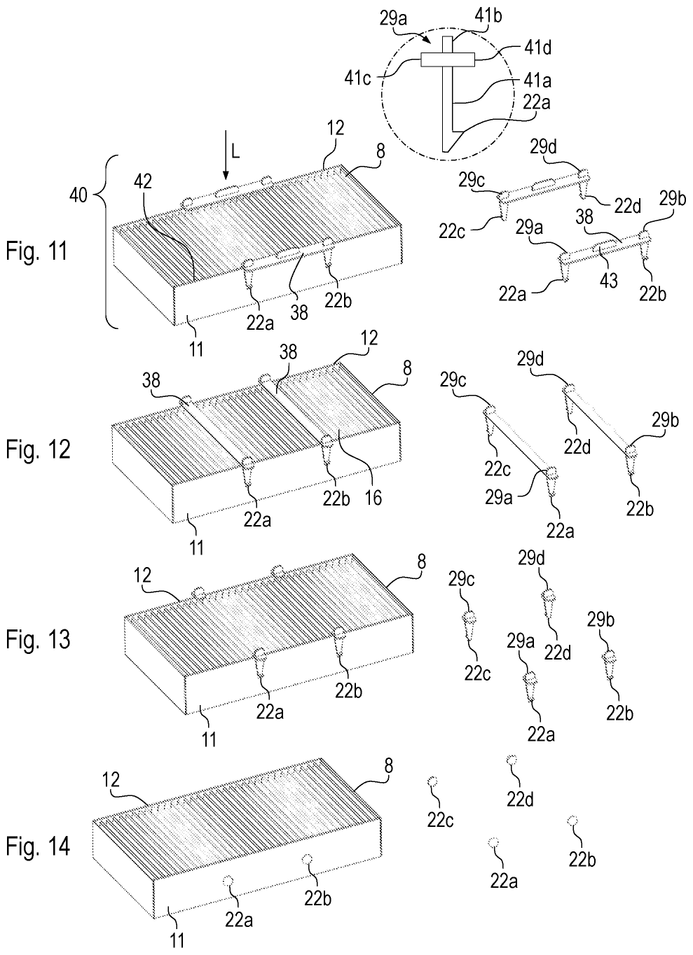

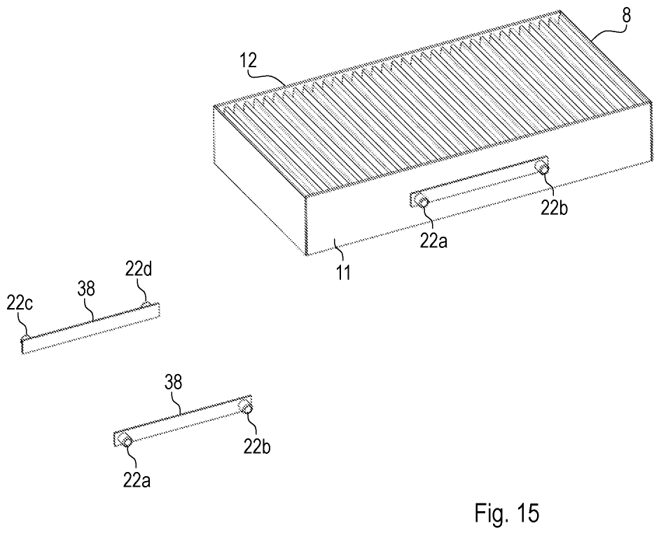

At the left side, FIG. 11 shows a filter element 8 with engagement elements 22a to 22d in a mounted position. The filter housing 7 is not illustrated for reasons of clarity. At the right side, the engagement elements 22a to 22d are illustrated in isolation together with connection pieces 38. In an enlarged illustration, a hold section 29a for the engagement element 22a is illustrated in an exemplary fashion in more detail.

According to the embodiment, the engagement elements 22a to 22d are embodied in the form of hooks. They are configured to engage with form fit the blocking sections 32 of the engagement counter elements 28a to 28d which are illustrated, for example, in FIG. 6. This is done in that the engagement elements 22a to 22d are pushed substantially along the flow direction L into a gap (not illustrated) between the filter element 8 and the wall section 24 or 25 (see FIG. 6). In doing so, the lateral faces 11, 12 are pushed elastically inwardly and provide then a contact pressure which holds the engagement elements 22a to 22d in engagement with the blocking sections 32.

The hold section 29a (see the enlarged view in FIG. 11) is presently embodied in an exemplary fashion in a cross shape and comprises four stays 41a to 41d. In FIG. 11, the stay 41a faces downwardly in this context. The engagement element 22a is integrally formed as one piece at its bottom end. The stay 41b faces vertically upwardly. It is embodied shorter than the stay 41a and serves, for example, as grip section for manually gripping the engagement elements 22a to 22d upon insertion or upon removal thereof in the context of mounting or demounting of the filter element 8. The stay 41c extends laterally and, for example, is also embodied shorter than the stay 41a. In relation to the engagement element 22a, the stay 41c engages an upper rim 42 of the lateral face (or of the lateral strip) 11. In this way, it is prevented that the filter element 8 can move along the flow direction L in relation to the filter housing 7. The stay 41d is also shorter than the stay 41a and engages from behind the rim 33 (see FIG. 6) of the filter housing 7. In this way, the fixation of the engagement elements 22a to 22d in the blocking sections 32 is further improved.

In the embodiment according to FIG. 11, the stays 41a to 41d form a one-piece component of the connection pieces 38. In addition, the connection pieces 38 comprise, for example, a further grip section in the form of a tab 43.

In the embodiment according to FIG. 11, a respective connection piece 38 connects two hold sections 29a, 29b or 29c, 29d or two engagement elements 22a, 22b or 22c, 22d which are arranged on the same side of a respective lateral face 11, 12. Correspondingly, the connection pieces 38 extend parallel to the lateral faces 11, 12. Two respective engagement elements 22a, 22b or 22c, 22d form together with two respective hold sections 29a, 29b or 29c, 29d and a connection piece 38 a separate part.

In contrast thereto, FIG. 12 shows an embodiment in which the connection pieces 38 connect hold sections 29a, 29c or 29b, 29d or engagement elements 22a, 22c or 22b, 22d at opposed lateral faces 11, 12 to each other. Correspondingly, the connection pieces 38 extend transversely to the lateral faces 11, 12. In addition, the connection pieces 38 extend above the fold edges 16. Two respective engagement elements 22a, 22c or 22b, 22d form with two respective hold sections 29a, 29c or 29b, 29d and a connection piece 38 a separate part. In the embodiment according to FIG. 12, the filter element 8 is completely engaged across by the hold sections 29a to 29d together with the connection pieces 38.

In the embodiment according to FIG. 13, the engagement elements 22a to 22d together with respective correlated hold sections 29a to 29d are formed as a separate part and are not connected to each other by means of connection pieces 38. Two engagement elements 22a to 22d together with correlated hold sections 29a to 29d are arranged at a lateral strip 11 or 12, respectively.

In the embodiment according to FIG. 14, the engagement elements 22a to 22d are fastened at the filter element 8, namely already prior to the first mounting step (see step S1 according to FIG. 16). In particular, the engagement elements 22a, 22b or 22c, 22d are glued to the lateral strips 11 or 12, welded thereto or formed as one piece therewith. According to the embodiment, the engagement elements are in the form of projections which project outwardly away from a respective lateral strip 11, 12, i.e., from the filter element 8. The engagement elements 22a to 22d according to FIG. 14 are, for example, embodied to engage the through holes 34 or corresponding pockets (see FIG. 6) with form fit.

In the embodiment according to FIG. 15, two respective engagement elements 22a, 22b or 22c and 22d are connected to each other by a connection piece 38, wherein the connection piece 38 is fastened, in particular glued, to a correlated lateral wall 11 or 12. The connection piece 38 in this case can also be configured to be elastic in order to permit a change of the distance d (see FIG. 6).

In this context, FIGS. 11 to 15 show a set 40, respectively, comprising a filter element 8 and engagement elements 22a to 22d. The set 40 is suitable for use with a filter housing 7, for example, as illustrated in FIG. 6. A filter element already present thereat can be exchanged by means of the set 40 in a simple manner, wherein preferably at least the steps S1 and S2 according to the method of FIG. 16, optionally also the step S3, are carried out.

Even though the present invention has been explained with the aid of some embodiments, it is not limited thereto but can be modified in many ways. Presently, “a” does not preclude a plurality.

### REFERENCE CHARACTERS

1 motor vehicle
2 air conditioning device
3 ambient air
4 air
5 cabin
6 filter device
7 filter housing
8 interior filter/filter element
9 filter medium/filter medium body
10 frame
11 lateral strip/lateral face
12 lateral strip/lateral face
13 head strip
14 head strip
15 fold
15a fold section
16 fold edge
17 end fold
18 end fold
19 fold end face edge
20 fold end face edge
21 seal
22a to 22d engagement elements
23 frame
24 wall section
25 wall section
26 wall section
27 wall section
28a to 28d engagement counter elements
29a to 29d hold sections
30 recessed region
31 insertion section
32 blocking section
33 rim
34 through hole
35 symmetry axis
36 through hole
37 bending axis
38 connection piece
40 set
41a to 41d stays
42 rim
43 tab
A1, A2 distances
D distance
d distance
E plane
F1, F2 surfaces
H, H= height
L flow direction
M machine direction
RO raw side/inflow side
RE clean side/outflow side
S1, S2, S3 method steps

What is claimed is:

1. A filter device comprising:
a filter element comprising a filter medium body and a frame surrounding the filter medium body, wherein the frame comprises opposed lateral faces;
engagement elements;
a filter housing comprising two opposed wall sections, wherein the two opposed wall sections each comprise two engagement counter elements;
wherein the engagement counter elements each are formed as a groove in the respective wall section and comprise an insertion section and a blocking section, wherein the blocking section is connected to the insertion section and angled in relation to the insertion section, wherein the blocking section is configured to receive with form fit a respective engagement element of the engagement elements, and wherein the insertion section is configured to permit an insertion movement of the respective engagement element substantially along a flow direction through the filter element in a mounted state of the filter element in the filter housing;
wherein, in the mounted state of the filter element in the filter housing, the respective engagement element is arranged at one of the opposed lateral faces of the frame, extends away from the filter medium body, and is held in the respective blocking section of the respective engagement counter element; and
wherein one or several of the engagement elements are embodied as separate parts and are fastenable detachably to the filter element.

2. The filter device according to claim 1, wherein the two engagement counter elements extend oppositely in the respective wall section.

3. The filter device according to claim 2, wherein the two engagement counter elements each comprise an L shape, wherein a first leg of the L shape is the insertion section and a second leg of the L shape is the blocking section, and wherein the L shapes of the two engagement counter elements are arranged mirror-symmetrically to each other in the respective wall section.

4. The filter device according to claim 2, wherein the blocking sections of the two engagement counter elements face away from each other in the respective wall section and the insertion sections of the two engagement counter elements are arranged parallel to each other in the respective wall section.

5. The filter device according to claim 2, wherein, in an undeformed state of the filter element, a first distance between two of the engagement elements arranged at one of the opposed lateral faces of the frame is larger than a second distance between the insertion sections of the two engagement counter elements of the respective wall section so that, at an end of the insertion movement, said two engagement elements snap into the respective blocking sections.

6. The filter device according to claim 1, wherein the respective blocking section comprises a pocket or a through opening in the respective wall section, wherein the respective engagement element engages with form fit the pocket or the through opening in the mounted state of the filter element in the filter housing.

7. The filter device according to claim 1, wherein the opposed lateral faces of the frame each comprise two through openings, wherein the two through openings, in the mounted state of the filter element in the filter housing, are positioned opposite the blocking sections of the engagement counter elements in the opposed wall sections, respectively, wherein, in the mounted state of the filter element in the filter housing, the respective engagement element passes through the respective through opening and engages with form fit the respective blocking section.

8. The filter device according to claim 1, further comprising hold sections connected to the engagement elements, wherein the hold sections are arranged, in the mounted state of the filter element in the filter housing, in a recessed region of the filter medium body, respectively, wherein the recessed region of the filter medium body is accessible from a side from which mounting of the filter element in the filter housing is carried out.

9. The filter device according to claim 1, further comprising hold sections connected to the engagement elements, wherein the hold sections, in the mounted state of the filter element in the filter housing, engage at least partially the filter element.

10. The filter device according to claim 9, wherein the filter element has an inflow side and an outflow side, wherein the hold sections engage the filter element at the inflow side; at the outflow side; or at the inflow side and the outflow side.

11. The filter device according to claim 9, wherein the hold sections each comprise a cross shape and the engagement elements are arranged at a bottom end of the cross shape, respectively, wherein the cross shape laterally engages a rim of the frame, wherein the rim is arranged at the inflow side and/or at the outflow side of the filter element.

12. The filter device according to claim 11, wherein the cross shape engages the wall sections of the filter housing, respectively.

13. The filter device according to claim 9, wherein the hold sections each comprise a cross shape and the engagement elements are arranged at a bottom end of the cross shape, respectively, wherein the cross shape engages the wall sections of the filter housing, respectively.

14. The filter device according to claim 9, wherein an upper end of the cross shape comprises a grip section for manually mounting the engagement elements arranged thereat.

15. The filter device according to claim 9, wherein two of the hold sections are connected by a connection piece, respectively.

16. The filter device according to claim 15, wherein the connection piece extends parallel or perpendicularly to the opposed lateral faces of the frame in the mounted state of the filter element in the filter housing.

17. The filter device according to claim 1, wherein two of the engagement elements are connected by a connection piece, respectively.

18. The filter device according to claim 17, wherein the connection piece is elastically deformable for introducing the two engagement elements connected by the connection piece into the respective blocking section.

19. The filter device according to claim 17, wherein the connection piece extends across fold tips of the filter medium body or extends in a recessed region through the filter medium body.

20. The filter device according to claim 17, wherein the connection piece extends across fold tips of the filter medium body and extends in a recessed region through the filter medium body.
